(19) United States
(12) Patent Application Publication
(10) Pub. No.: US 2024/0097261 A1
(43) Pub. Date: Mar. 21, 2024

(54) Modular Battery Enclosure

(71) Applicant: BH Electrics LLC, Lancaster, PA (US)

(72) Inventors: Brandon Hollinger, Lancaster, PA (US); Charles Cook, Elizabethtown, PA (US)

(73) Assignee: BH Electrics LLC, Lancaster, PA (US)

(21) Appl. No.: 18/526,886

(22) Filed: Dec. 1, 2023

Related U.S. Application Data
(63) Continuation of application No. PCT/US22/32182, filed on Jun. 3, 2022.
(60) Provisional application No. 63/196,373, filed on Jun. 3, 2021.

(51) Int. Cl. H01M 50/258; H01M 50/209; H01M 50/224; H01M 50/262; H01M 50/291

(52) U.S. Cl. CPC H01M 50/258; H01M 50/209; H01M 50/224; H01M 50/262; H01M 50/291

(57) ABSTRACT

A modular enclosure is provided. The modular enclosure is a protective enclosure which can be assembled from individual, similar components to increase in size and expand in both the horizontal axis and vertical axis in order to contain an increased number of energy cells, batteries or battery modules is provided. The modular enclosure can include thermal regulation with the use of passive air ducting, active coolant, fans or resistant heat for the energy cells, batteries or battery modules. The modular enclosure may include a high voltage fuse which can be mounted on the modular battery enclosure.

### CROSS-REFERENCE TO RELATED APPLICATION

This application is a continuation of PCT International Application No. PCT/US2022/32182 filed Jun. 3, 2022, which claims the benefit of the filing date under 35 U.S.C. § 119(a)-(d) of the U.S. Provisional Application No. 63/196,373 filed Jun. 3, 2021.

### FIELD OF INVENTION

The invention relates to a modular enclosure, and more particularly, to a modular battery enclosure which can expand to contain multiple batteries.

### BACKGROUND

A historic upsurge in battery research and funding has been witnessed in recent years in part due to growing public awareness of both climate change and broad advances in battery technology. A focus on increasing battery energy density and power density has been the trend in order to achieve an even smaller form factor leading to both longer run-time and higher power output. With growing demand for energy storage solutions, both stationary and mobile, comes a need for safe, adequately protective battery containment. The traditional response to this demand requires the production, storage and shipment of enclosures across a multitude of shapes and sizes.

### SUMMARY

The following is intended to be a brief summary of the invention and is not intended to limit the scope of the invention. A modular, protective enclosure which can be assembled from individual, similar components to increase in size and expand in both the horizontal axis and vertical axis in order to contain an increased number of energy cells, batteries or battery modules is provided. The modular enclosure can include thermal regulation with the use of passive air ducting, active coolant, fans or resistant heat for the energy cells, batteries or battery modules. The modular enclosure may include a high voltage fuse which can be mounted on the modular battery enclosure.

### BRIEF DESCRIPTION OF THE DRAWINGS

The invention will now be described by way of example with reference to the accompanying Figures of which:

FIG. 1 is a front, left-side, top perspective view of the modular enclosure;

FIG. 2 is a left-side, perspective view of the invention of FIG. 1;

FIG. 3 is an isometric view of the invention of FIG. 2;

FIG. 4 is a front, top, left-side perspective view of the invention of FIG. 3;

FIG. 5 is a front, top, left-side perspective view of the invention of FIG. 4;

FIG. 6 is an exploded view of the invention of FIG. 5;

FIG. 7 is a front, top, left-side perspective view of the invention of FIG. 6;

FIG. 8 is a front, top, left-side alternate view of the invention of FIG. 7;

FIG. 9 is a front, top, left-side alternate view of the invention of FIG. 8;

FIG. 10 is an enlarged view of the invention of FIG. 9;

FIG. 11 is an alternate view of the invention of FIG. 10;

FIG. 12 is a front, top, left-side alternate view of the invention of FIG. 11;

FIG. 13 is an alternate view of the invention of FIG. 12;

FIG. 14 is an enlarged view of the invention of FIG. 13;

FIG. 15 is a front, top, left-side perspective view of the invention of FIG. 14; and

FIG. 16 is an enlarged view of the invention of FIG. 15.

### DETAILED DESCRIPTION OF THE EMBODIMENT(S)

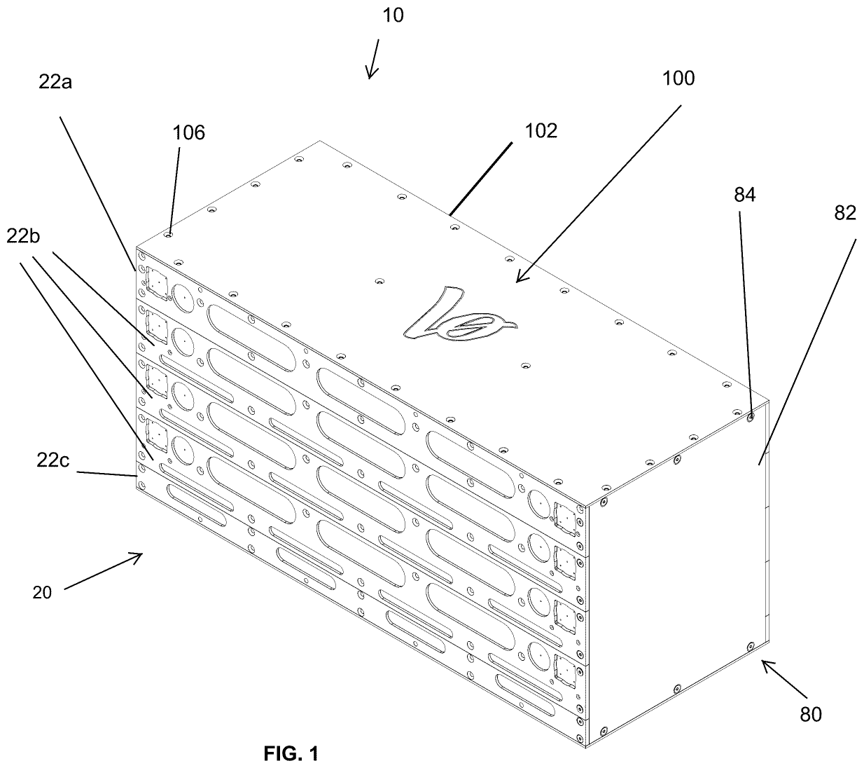

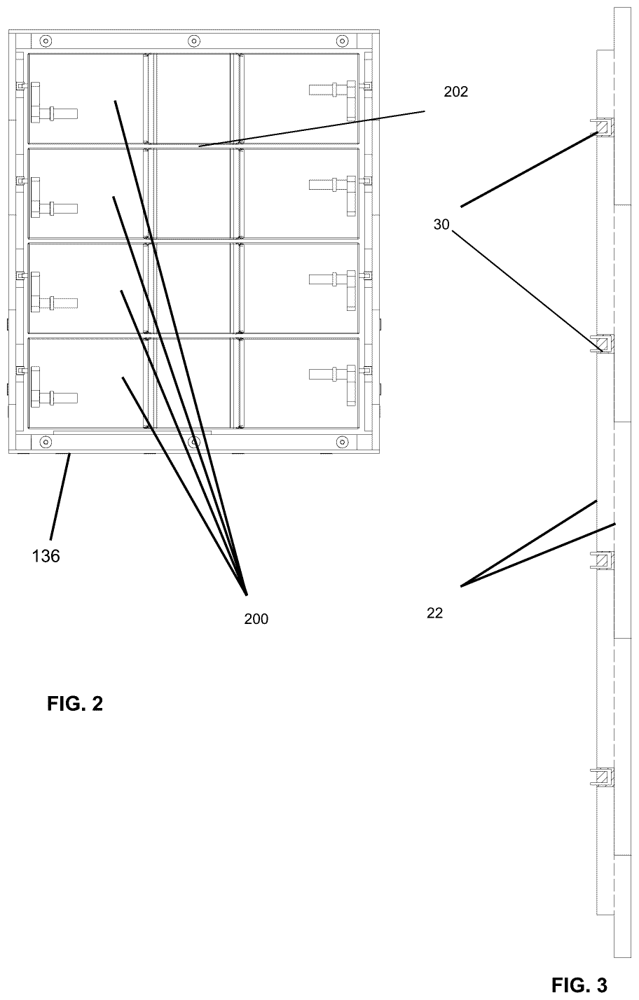

Referring to FIGS. 1-16, a modular enclosure 1 according to the invention is shown.

As shown, the modular enclosure 1 generally includes the following major component: an enclosure shell 10. One of ordinary skill in the art would understand the applicant's design is not the exclusive embodiment.

In the exemplary embodiment, the enclosure shell 10 generally includes a modular wall stacker 20, a front enclosure 60, a rear enclosure 80, a top enclosure 100, a bottom enclosure 130 and a battery assist 160. One of ordinary skill in the art would understand the applicant's design is not the exclusive embodiment.

In the exemplary embodiment, the modular wall stacker 20 generally includes the following components: a plurality of side plates 22 and a battery stopper 24. One of ordinary skill in the art would understand the applicant's design is not the exclusive embodiment.

In the exemplary embodiment, the plurality of side plates 22 include a pair of upper side plates 22a, a pair of middle side plates 22b and a pair of lower side plates 22c. One of ordinary skill in the art would understand the applicant's design is not the exclusive embodiment.

In the exemplary embodiment, the pair of upper side plates 22a include an upper elongated rectangular member Y and an upper elongated ovular member X. One of ordinary skill in the art would understand the applicant's design is not the exclusive embodiment. In the exemplary embodiment, the upper elongated rectangular member Y and the upper elongated ovular member X form an upper ledge Z. One of ordinary skill in the art would understand the applicant's design is not the exclusive embodiment. In the exemplary embodiment, the pair of upper side plates 22a further include a plurality of upper locker fastener receivers 42a located in the lower region of the upper elongated rectangular member Y. One of ordinary skill in the art would understand the applicant's design is not the exclusive embodiment. In the exemplary embodiment, the pair of upper side plates 22a further include a plurality of upper battery stop securing connectors 32a extending there through. One of ordinary skill in the art would understand the applicant's design is not the exclusive embodiment.

In the exemplary embodiment, the pair of middle side plates 22b include a first middle rectangular member Q and a second middle rectangular member R. One of ordinary skill in the art would understand the applicant's design is not the exclusive embodiment. In the exemplary embodiment, the first middle rectangular member Q and the second middle rectangular member R form a middle ledge S. One of ordinary skill in the art would understand the applicant's design is not the exclusive embodiment. In the exemplary embodiment, the pair of middle side plates 22b further include a plurality of middle locker fastener receivers 42b located in the lower region of the first middle rectangular member Q. In the exemplary embodiment, the pair of middle side plates 22b further include a plurality of middle battery stop securing connectors 32b extending there through. One of ordinary skill in the art would understand the applicant's design is not the exclusive embodiment.

In the exemplary embodiment, the pair of lower side plates 22c include a first lower rectangular member E and a second lower rectangular member F. One of ordinary skill in the art would understand the applicant's design is not the exclusive embodiment. In the exemplary embodiment, the first lower rectangular member E and the second lower rectangular member F form a lower ledge G. One of ordinary skill in the art would understand the applicant's design is not the exclusive embodiment. In the exemplary embodiment, the pair of lower side plates 22c further includes a plurality of lower locker fastener receivers 42c located in the upper region of the first lower rectangular member E. One of ordinary skill in the art would understand the applicant's design is not the exclusive embodiment.

In the exemplary embodiment, the plurality of side plates 22 may include a composition composed of 6061 billet aluminum. One of ordinary skill in the art would understand the applicant's use of 6061 billet aluminum is not the exclusive embodiment and compositions composed of different grades of aluminum can be applied. In an alternate embodiment, the plurality of side plates 22 may be fashioned out of a plastic composition, a polymer composition, a wooden composition, a steel composition, a metallic alloy composition, a brass composition, a copper composition or a metal casting or composite materials such as carbon fiber or fiberglass. One of ordinary skill in the art would understand the applicant's design is not the exclusive embodiment.

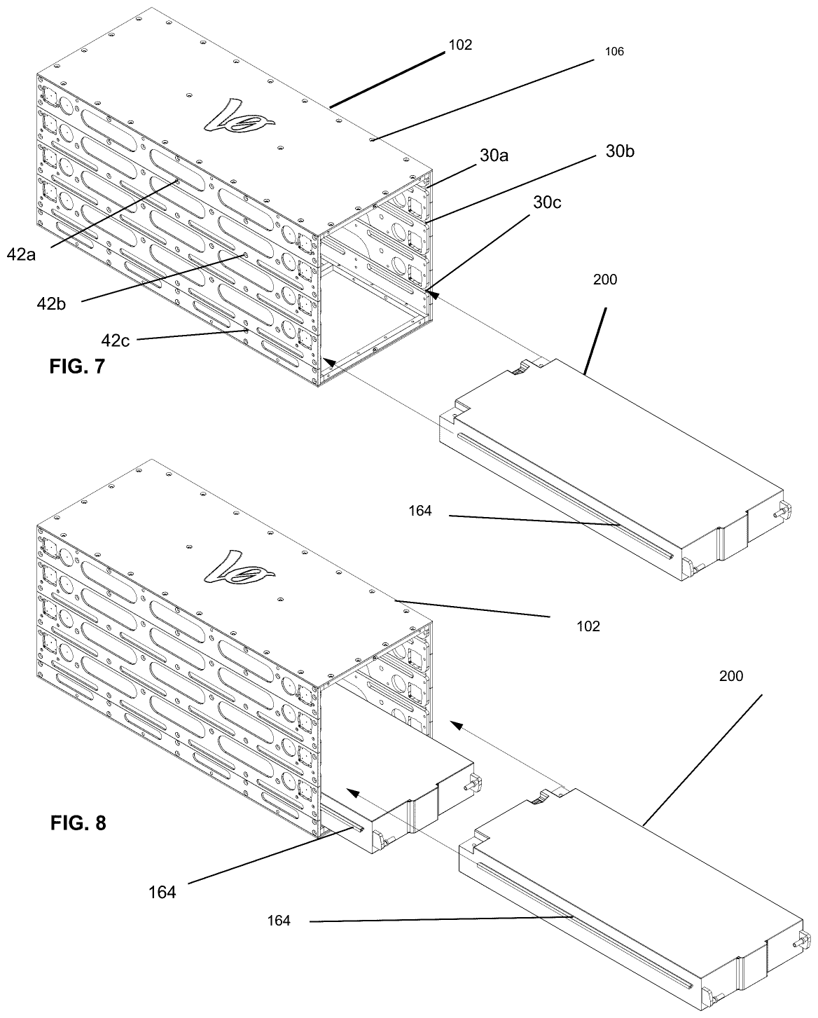

In the exemplary embodiment, the plurality of side plates 22 further include a plurality of battery receivers 30 and are formed when two more side plates from the plurality of side plates 22 are interlocked as shown in FIG. 7. One of ordinary skill in the art would understand the applicant's design is not the exclusive embodiment.

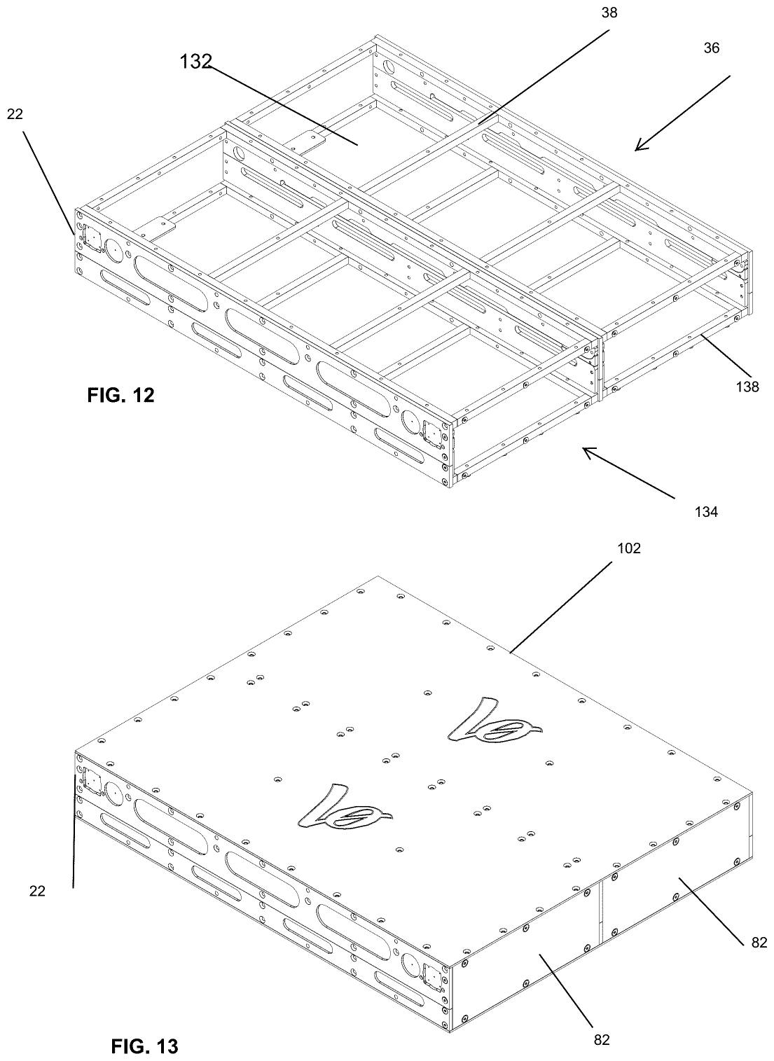

In an alternate embodiment, the plurality of side plates 22 may include a side plate structural box frame 36 as shown in FIG. 12. The side plate structural box frame 36 is comprised of a plurality of connector bars 38. One of ordinary skill in the art would understand the applicant's design is not the exclusive embodiment. In the exemplary embodiment, the plurality of connector bars 38 are ½ by ½ inch square bars of billet aluminum. One of ordinary skill in the art would understand the applicant's design is not the exclusive embodiment. In the exemplary embodiment, the side plate structural box frame 36 is two welded, for connecting the plurality of connector bars 38. One of ordinary skill in the art would understand the applicant's design is not the exclusive embodiment. In the exemplary embodiment, the side plate structural box frame 36 further includes a plurality of frame receivers 40. One of ordinary skill in the art would understand the applicant's design is not the exclusive embodiment.

In the exemplary embodiment, the battery stopper 24 is an elongated member with a curved tip, located in the lower region as shown in FIG. 10. One of ordinary skill in the art would understand the applicant's design is not the exclusive embodiment.

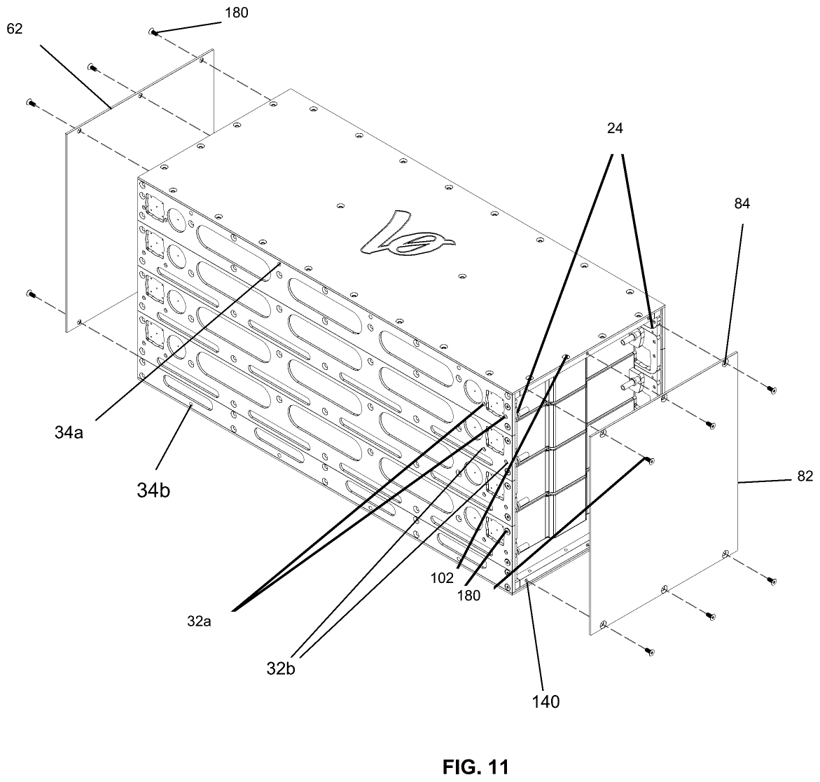

In the exemplary embodiment, the front enclosure 60 is a front sheet member 62 as shown in FIG. 11. One of ordinary skill in the art would understand the applicant's design is not the exclusive embodiment. In one embodiment, the front enclosure 60 may have a structural design of a ⅛ aluminum plate. One of ordinary skill in the art would understand the applicant's design is not the exclusive embodiment. In the exemplary embodiment, the front enclosure 60 further includes a plurality of front enclosure fastener receivers 64 located on the perimeter of the front sheet member 62. One of ordinary skill in the art would understand the applicant's design is not the exclusive embodiment.

In the exemplary embodiment, the rear enclosure 80 is a rear sheet member 82 as shown in FIG. 11. One of ordinary skill in the art would understand the applicant's design is not the exclusive embodiment. In one embodiment, the rear enclosure 80 may have a structural design of a ⅛ aluminum plate. One of ordinary skill in the art would understand the applicant's design is not the exclusive embodiment. In the exemplary embodiment, the rear enclosure 80 further includes a plurality of rear enclosure fastener receivers 84 located on the perimeter of the rear sheet member 82. One of ordinary skill in the art would understand the applicant's design is not the exclusive embodiment.

In the exemplary embodiment, the top enclosure 100 is generally constructed with a top elongated member 102 and a top structural frame 104 as shown in FIG. 1. One of ordinary skill in the art would understand the applicant's design is not the exclusive embodiment.

In one embodiment, the top elongated member 102 may have a structural design of a ⅛ aluminum plate. One of ordinary skill in the art would understand the applicant's design is not the exclusive embodiment. In the exemplary embodiment, the top enclosure 100 further includes a plurality of top enclosure fastener receivers 106 located around the perimeter of the top elongated member 102. One of ordinary skill in the art would understand the applicant's design is not the exclusive embodiment.

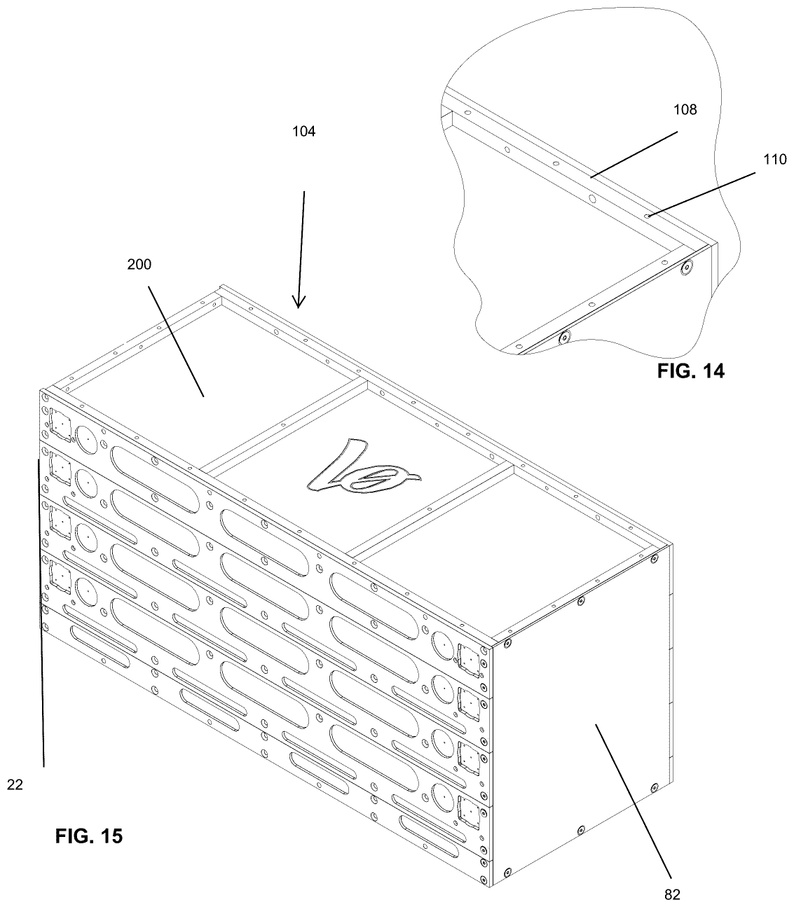

In the exemplary embodiment, the top structural frame 104 is located below the top elongated member 102. The top structural frame 104 is comprised of a plurality of top connector bars 108 as shown in FIGS. 14-15. One of ordinary skill in the art would understand the applicant's design is not the exclusive embodiment. In the exemplary embodiment, the plurality of top connector bars 108 are ½ by ½ inch square bars of billet aluminum. One of ordinary skill in the art would understand the applicant's design is not the exclusive embodiment. In the exemplary embodiment, the top structural frame 104 is two welded, for connecting the plurality of top connector bars 108. One of ordinary skill in the art would understand the applicant's design is not the exclusive embodiment. In the exemplary embodiment, the top structural frame 104 further includes a plurality of top structural frame fastener receivers 110. One of ordinary skill in the art would understand the applicant's design is not the exclusive embodiment. In the exemplary embodiment, the bottom enclosure 130 consists of a bottom elongated member 132 and a bottom structural frame 134. One of ordinary skill in the art would understand the applicant's design is not the exclusive embodiment. In one embodiment, the bottom elongated member 132 may have a structural design of a ⅛ aluminum plate. One of ordinary skill in the art would understand the applicant's design is not the exclusive embodiment. In the exemplary embodiment, the bottom enclosure 130 further includes a plurality of bottom enclosure fastener receivers 136 located around the perimeter of the bottom elongated member 132. One of ordinary skill in the art would understand the applicant's design is not the exclusive embodiment.

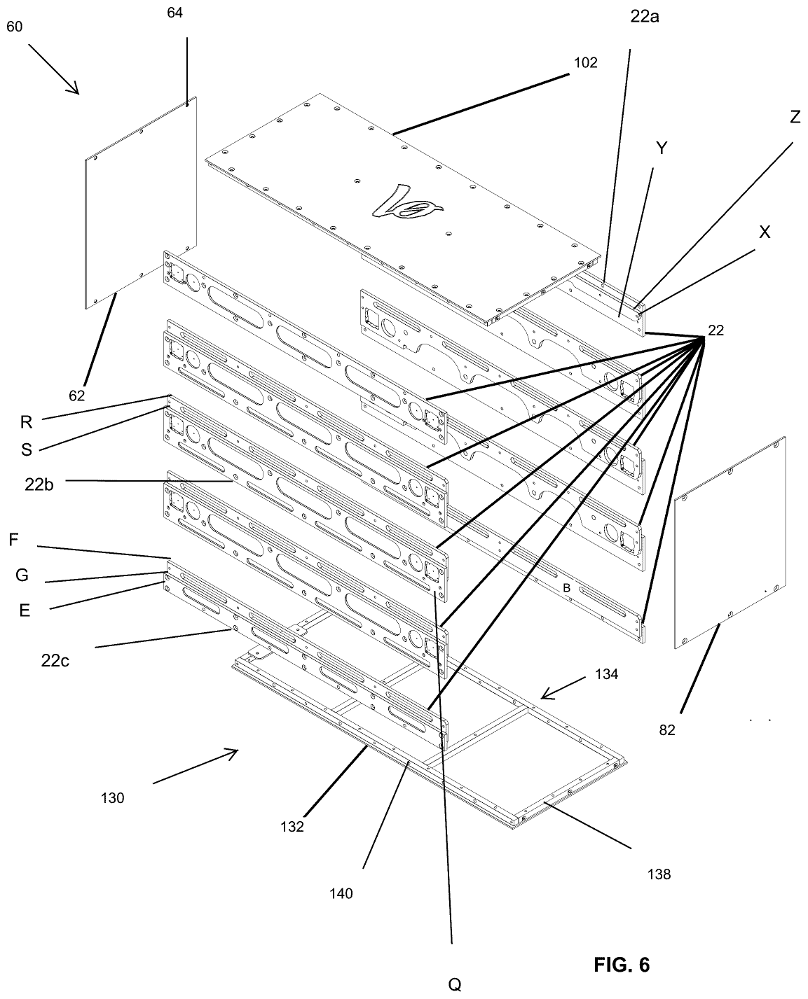

In the exemplary embodiment, the bottom structural frame 134 is located above the bottom elongated member 132 as shown in FIG. 6. The bottom structural frame 134 is comprised of a plurality of bottom connector bars 138. One of ordinary skill in the art would understand the applicant's design is not the exclusive embodiment. In the exemplary embodiment, the plurality of bottom connector bars 138 are ½ by ½ inch square bars of billet aluminum. One of ordinary skill in the art would understand the applicant's design is not the exclusive embodiment. In the exemplary embodiment, the bottom structural frame 134 is two welded, for connecting the plurality of bottom connector bars 138. One of ordinary skill in the art would understand the applicant's design is not the exclusive embodiment. In the exemplary embodiment, the bottom structural frame 134 further includes a plurality of bottom structural frame fastener receivers 140. One of ordinary skill in the art would understand the applicant's design is not the exclusive embodiment.

In the exemplary embodiment, the battery assist 160 is generally constructed with the following components: a set of battery mounting flanges 162, a set of u-channel extrusions 164, a high voltage mount 166 and battery manifolds 170. One of ordinary skill in the art would understand the applicant's design is not the exclusive embodiment.

In the exemplary embodiment, the set of battery mounting flanges 162 are receivers fixed to the two corresponding sides of a battery 200. One of ordinary skill in the art would understand the applicant's design is not the exclusive embodiment.

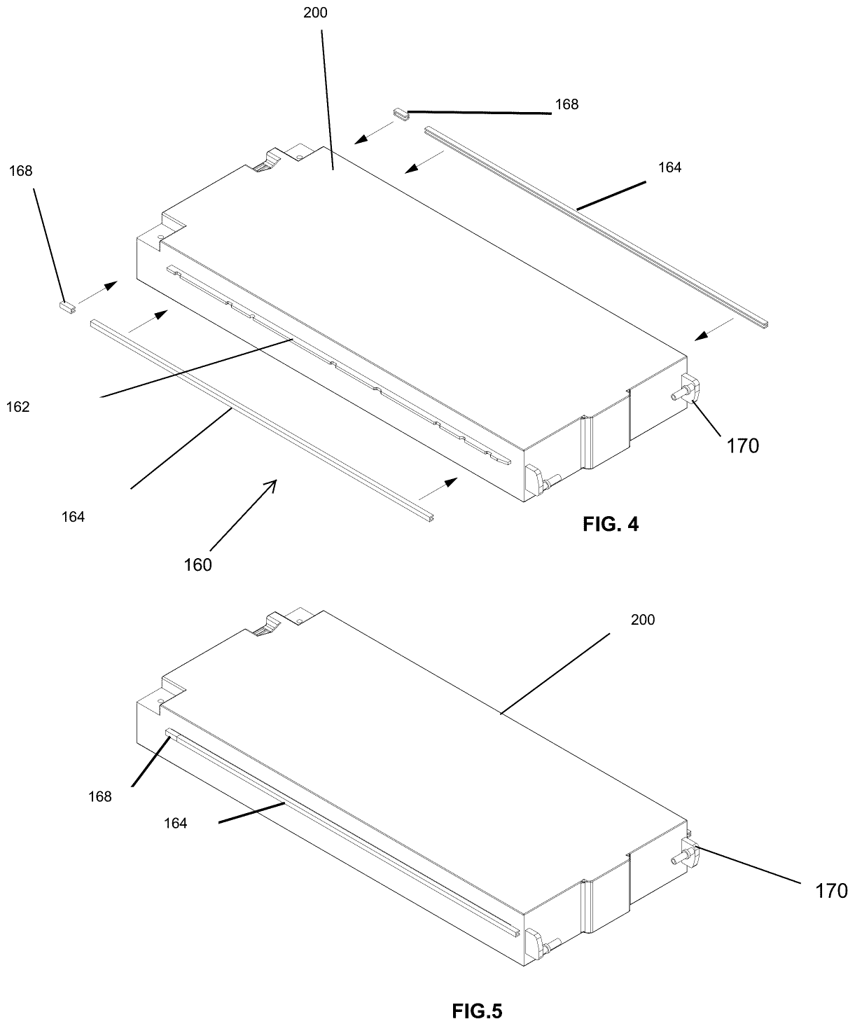

In the exemplary embodiment, the set of u-channel extrusions 164 are cut to the appropriate length to correlate to the battery mounting flanges 162 as shown in FIGS. 4-5. One of ordinary skill in the art would understand the applicant's design is not the exclusive embodiment. In the exemplary embodiment, the set of u-channel extrusions 164 may include a composition composed of nylon. One of ordinary skill in the art would understand the applicant's design is not the exclusive embodiment. In the exemplary embodiment, the set of u-channel extrusions 164 further include u-channel end caps 168. One of ordinary skill in the art would understand the applicant's design is not the exclusive embodiment. In the exemplary embodiment, the u-channel end caps 168 may include a composition composed of nylon. One of ordinary skill in the art would understand the applicant's design is not the exclusive embodiment.

In the exemplary embodiment, the high voltage mount 166 is a plate mount member. One of ordinary skill in the art would understand the applicant's design is not the exclusive embodiment. In the exemplary embodiment, the high voltage mount 166 is composed of aluminum and located in the vicinity of the battery electrical connectors as shown in FIG. 5. One of ordinary skill in the art would understand the applicant's design is not the exclusive embodiment.

In the exemplary embodiment, the battery manifolds 170 are plate like members with a cylindrical protrusion extending from one side thereof. One of ordinary skill in the art would understand the applicant's design is not the exclusive embodiment.

In the exemplary embodiment, depending on the dimensions of the power source, the plurality of side plates 22 will be connected with one another as shown in FIGS. 6-7. One of ordinary skill in the art would understand the applicant's design is not the exclusive embodiment.

In the exemplary embodiment, the upper elongated ovular member X is fastened to the rear of the upper rectangular member Y. One of ordinary skill in the art would understand the applicant's design is not the exclusive embodiment.

In the exemplary embodiment, the second middle rectangular member R is fastened to the rear of first middle rectangular member Q. One of ordinary skill in the art would understand the applicant's design is not the exclusive embodiment.

In the exemplary embodiment, the second lower rectangular member F is fastened to the rear of the first lower rectangular member E. One of ordinary skill in the art would understand the applicant's design is not the exclusive embodiment.

In the exemplary embodiment, the upper side plate of the pair of upper side plates 22a is secured to the middle ledge S of one of the middle side plates 22b. A plurality of fasteners 180 are then run though the upper locker fastener receivers 42a. One of ordinary skill in the art would understand the applicant's design is not the exclusive embodiment. In the exemplary embodiment, combining the pair of upper side plates 22a with the pair of middle side plates 22b forms an upper battery receiver 30a. One of ordinary skill in the art would understand the applicant's design is not the exclusive embodiment.

In the exemplary embodiment, if the user requires more than one layer of middle side plates 22b for the modular enclosure, the plurality of side plates 22 may be stackable. In the exemplary embodiment, a first pair of middle side plates 22b are connected to a second pair of middle side plates 22b by aligning the first middle rectangular member Q of the first pair of middle side plates 22b to the middle ledge S of the second pair of middle side plates 22b. A plurality of fasteners 180 are then run through the middle locker fastener receivers 42b. One of ordinary skill in the art would understand the applicant's design is not the exclusive embodiment. In the exemplary embodiment, combining the first pair and the second pair of middle side plates 22b forms a middle battery receiver 30b.

In the exemplary embodiment, the pair of lower side plates 22c is connected to the pair of middle side plates 22b by aligning the middle rectangular member Q of the pair of middle side plates to the lower ledge G of the pair of lower side plates 22c. A plurality of fasteners 180 are then run through the lower locker fastener receivers 42c. One of ordinary skill in the art would understand the applicant's design is not the exclusive embodiment. In the exemplary embodiment, combining the pair of middle side plates 22b with the pair of lower side plates 22c forms a lower battery receiver 30c. One of ordinary skill in the art would understand the applicant's design is not the exclusive embodiment. In the exemplary embodiment, the plurality of side plates 22 are staggered, leaving offsets of 1-inch to 2.25-inch overlap. One of ordinary skill in the art would understand the applicant's design is not the exclusive embodiment.

In an alternate embodiment, the modular enclosure 1 includes the plurality of side plates 22 further including the side plate structural box frame 36 where the side plate structural box frame 36 is fastened to each of the plurality of side plates 22 as shown in FIG. 12. One of ordinary skill in the art would understand the applicant's design is not the exclusive embodiment. In the exemplary embodiment, the plurality of side plates 22 are drilled, tapped and countersunk and are fastened to each other with a plurality of fasteners 180. One of ordinary skill in the art would understand the applicant's design is not the exclusive embodiment. In one embodiment, the plurality of fasteners 180 may be ½-inch and ⅝-inch-long stainless steel, countersunk, flathead M5×0.8 screws. One of ordinary skill in the art would understand the applicant's design is not the exclusive embodiment. In the exemplary embodiment, the plurality of fasteners 180 are inserted into the plurality of locker fastener receivers 42 to produce a ½-inch thick side walls.

One of ordinary skill in the art would understand the applicant's design is not the exclusive embodiment.

In the exemplary embodiment, the bottom structural frame 134 is fixed to the bottom elongated member 132 by inserting the plurality of fasteners 180 through both the bottom enclosure fastener receivers 136 and the bottom structural frame fastener receivers 140. One of ordinary skill in the art would understand the applicant's design is not the exclusive embodiment. In the exemplary embodiment, the pair of lower side plates of the plurality of side plates 22 are connected to the bottom structural frame 134 by inserting the plurality of fasteners 180 through both the bottom structural frame fastener receivers 140 and the lower side plate fastener receivers 34b. One of ordinary skill in the art would understand the applicant's design is not the exclusive embodiment.

In the exemplary embodiment, the top structural frame 104 is fixed to the top elongated member 102 by inserting a plurality of fasteners 180 through both the top enclosure fastener receivers 106 and the top structural frame fastener receivers 110. One of ordinary skill in the art would understand the applicant's design is not the exclusive embodiment. In the exemplary embodiment, the pair of upper side plates 22a of the plurality of side plates 22 are connected to the top structural frame 104 by inserting the plurality of fasteners 180 through both the top structural frame fastener receivers 110 and the top side plate fastener receivers 34a. One of ordinary skill in the art would understand the applicant's design is not the exclusive embodiment.

In the exemplary embodiment, the front enclosure 60 is connected to the bottom enclosure 130 by aligning and inserting a plurality of fasteners 180 through both the front enclosure fastener receivers 64 and the bottom structural frame fastener receivers 140 as shown in FIG. 11 Similarly, the front enclosure 60 is connected to the top enclosure 100 by aligning and inserting the plurality of fasteners 180 through both the front enclosure fastener receivers 64 and the top structural frame fastener receivers 110. One of ordinary skill in the art would understand the applicant's design is not the exclusive embodiment.

In the exemplary embodiment, the battery mounting flanges 162 of the battery assist 160 are fixed to parallel sides of a battery 200. One of ordinary skill in the art would understand the applicant's design is not the exclusive embodiment. In the exemplary embodiment, the set of u-channel extrusions 164 and the u-channel end caps 168 are fixed to the battery mounting flanges 162 as shown in FIG. 5. One of ordinary skill in the art would understand the applicant's design is not the exclusive embodiment. In the exemplary embodiment, the battery manifolds 170 are fixed to the rear of the battery 200. One of ordinary skill in the art would understand the applicants design is not the exclusive embodiment.

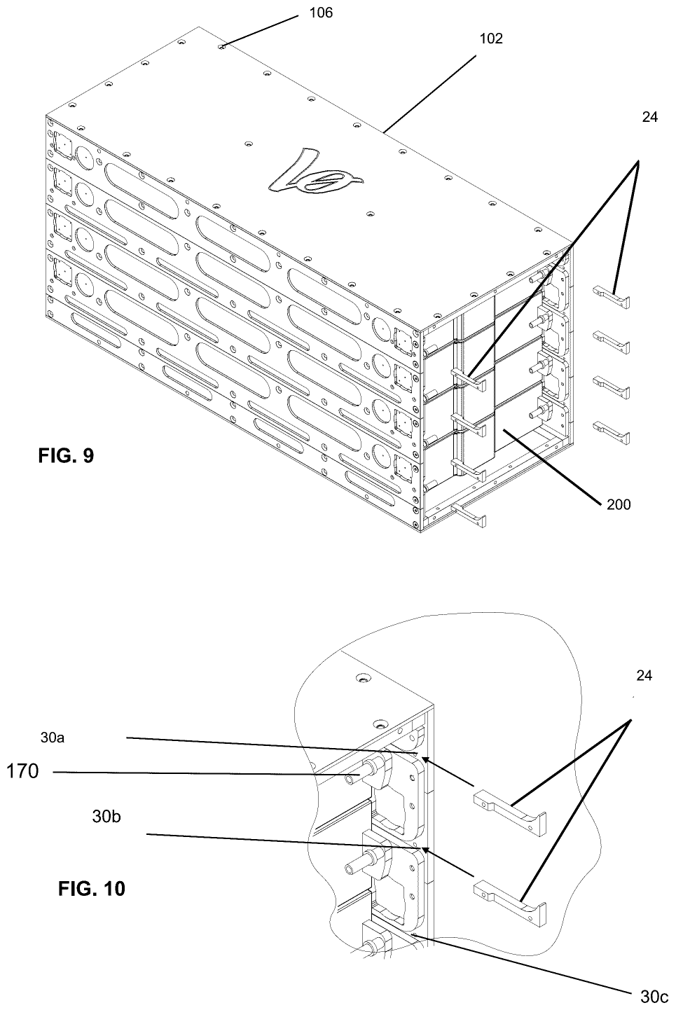

In the exemplary embodiment, a user inserts the battery 200 into the modular enclosure 1 as shown in FIGS. 9-10. Specifically, the set of u-channel extrusions 164 that are fixed to the battery 200 which interfaces with either the upper battery receiver 30a, the middle battery receiver 30b or the lower battery receiver 30c depending on where the user inserts the battery

200. One of ordinary skill in the art would understand the applicant's design is not the exclusive embodiment. The user then inserts the battery stopper 24 into one of the plurality of battery receivers 30 in order to completely restrict the movement of the battery 200 as well as keep the battery 200 completely electrically and vibrationally isolated from the modular enclosure 1 that contains and protects them. One of ordinary skill in the art would understand the applicant's design is not the exclusive embodiment. The plurality of battery stoppers 24 are secured in place by the plurality of battery stop securing connectors 32. The plurality of battery stop securing connectors 32 may include four ½ inch #10-32 screws. One of ordinary skill in the art would understand the applicant's design is not the exclusive embodiment. In an alternate embodiment, the present invention includes an intentionally adequate gap 202 designed to install plumbing, fans or resistive heat coils in the enclosure to thermally regulate the heating or cooling of the battery. One of ordinary skill in the art would understand the applicant's design is not the exclusive embodiment.

In the exemplary embodiment, the rear enclosure 80 is connected to the bottom enclosure 130 by aligning and inserting a plurality of fasteners 180 through both the rear enclosure fastener receivers 84 and the bottom structural frame fastener receivers 140. Similarly, the rear enclosure 80 is connected to the top enclosure 100 by aligning and inserting the plurality of fasteners 180 through both the rear enclosure fastener receivers 84 and the top structural frame fastener receivers 110. One of ordinary skill in the art would understand the applicant's design is not the exclusive embodiment.

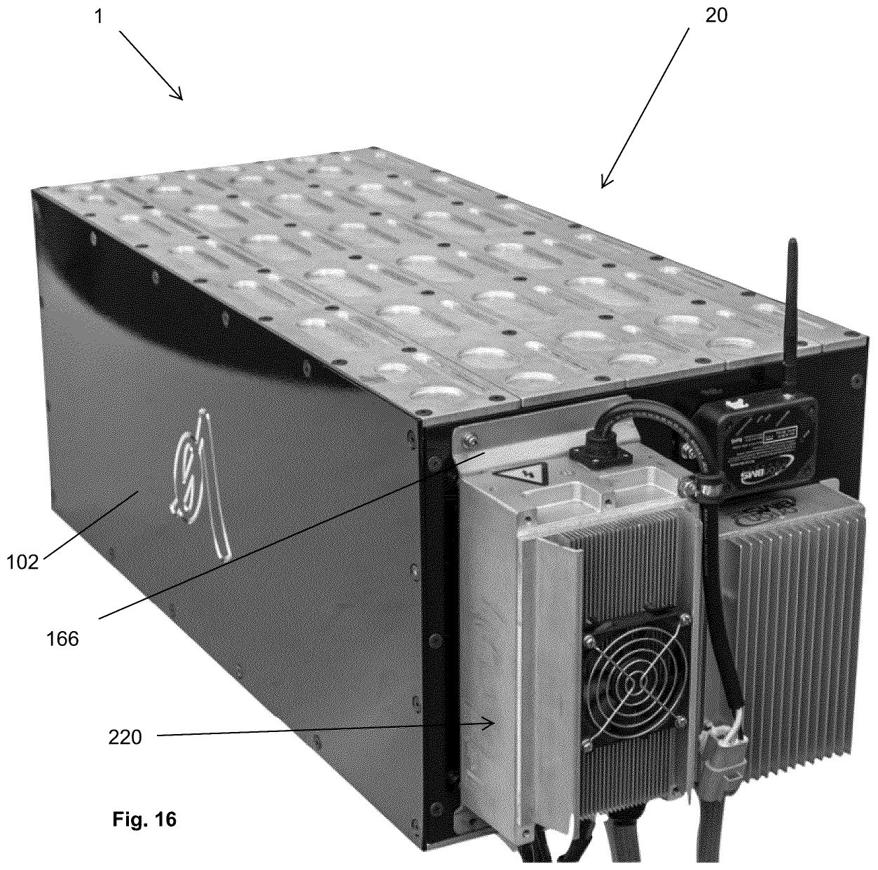

In an alternate embodiment, the high voltage mount 166 is drilled and tapped in the vicinity of the battery electrical connections on either the front enclosure 60 or the rear enclosure 80 for mounting a standard high voltage traction pack fuse 220 as shown in FIG. 16. One of ordinary skill in the art would understand the applicant's design is not the exclusive embodiment.

In the foregoing description, the invention has been described with reference to specific embodiments thereof. It will be evident, however, that various modifications and changes may be made thereto without departing from the broader spirit and scope of the invention. For example, the reader is to understand that the specific ordering and combination of process actions

described herein is merely illustrative, and the invention may appropriately be performed using different or additional process actions, or a different combination or ordering of process actions, including the ability for the user to personalize. Additionally, and obviously, feature may be added or subtracted as desired. Accordingly, the invention is not to be restricted.

What is claimed is:

1. A modular enclosure comprising an enclosure shell expandable in both a horizontal axis and a vertical axis in order to house a plurality of power sources, the enclosure shell having:
a modular wall stacker having a plurality of side plates stackable upon one another, each of the plurality of side plates connecting to form a plurality of battery receivers;
a front enclosure connected to one side of the plurality of side plates;
a rear enclosure connected to an opposite side of the plurality of side plates positioned opposite the front enclosure;
a top enclosure connected to a pair of upper side plates of the plurality of side plates, the front enclosure, and the rear enclosure; and
a bottom enclosure connected to a pair of lower side plates of the plurality of side plates, the front enclosure, and the rear enclosure;
a battery assist having a set of battery mounting flanges and a set of u-channel extrusions for insertion of a power source into one of the plurality of battery receivers, wherein the channel extrusions interfaces with one of the plurality of battery receivers and secured between the plurality of side plates.

2. The modular enclosure of claim 1, wherein the plurality of side plates include a pair of upper side plates, a pair of middle side plates and a pair of lower side plates.

3. The modular enclosure of claim 2, wherein the pair of upper side plates include an upper elongated rectangular member and an upper elongated ovular member which form an upper ledge.

4. The modular enclosure of claim 3, wherein the pair of upper side plates further include a plurality of upper locker fastener receivers located in a lower region of the upper elongated rectangular member.

5. The modular enclosure of claim 4, wherein the pair of middle side plates include a first middle rectangular member Q and a second middle rectangular member R which form a middle ledge S.

6. The modular enclosure of claim 5, wherein the pair of middle side plates further include a plurality of middle locker fastener receivers located in the lower region of the first middle rectangular member.

7. The modular enclosure of claim 6, wherein pair of lower side plates include a first lower rectangular member and a second lower rectangular member which form a lower ledge.

8. The modular enclosure of claim 7, wherein the pair of lower side plates further includes a plurality of lower locker fastener receivers located in the upper region of the first lower rectangular member.

9. The modular enclosure of claim 8, wherein the plurality of side plates include a composition composed of an aluminum composition or a composition composed of a plastic composition, a composition composed of a polymer composition, a composition composed of a wood composition, a composition composed of a steel composition, a composition composed of a metallic alloy composition, a composition composed of a brass composition, a composition composed of a copper composition, a composition composed of a metal casting composition or a composition composed of a plurality of composite materials such as carbon fiber or fiberglass.

10. The modular enclosure of claim 9, wherein the plurality of side plates further include a plurality of battery receivers and are formed when two more of the side plates from the plurality of side plates are interlocked.

11. The modular enclosure of claim 10, wherein the plurality of side plates may include a side plate structural box frame.

12. The modular enclosure of claim 11, a battery stopper is an elongated member with a curved tip, located in the lower region as shown in FIG. 10.

13. The modular enclosure of claim 12, wherein the front enclosure is a front sheet member with a plurality of front enclosure fastener receivers located on the perimeter of the front sheet member.

14. The modular enclosure of claim 13, wherein the rear enclosure is a rear sheet member and includes a plurality of rear enclosure fastener receivers located on the perimeter of the rear sheet member.

15. The modular enclosure of claim 14, wherein the top enclosure includes a top elongated member and a top structural frame.

16. The modular enclosure of claim 15, wherein the bottom enclosure includes a bottom elongated member and a bottom structural frame.

17. The modular enclosure of claim 16, wherein the set of battery mounting flanges are receivers fixed to the two corresponding sides of the power source while the set of u-channel extrusions are cut to the appropriate length to correlate to the battery mounting flanges.

18. The modular enclosure of claim 17, wherein a high voltage mount is composed of aluminum and located in the vicinity of a power source electrical connectors.

19. The modular enclosure of claim 18, wherein the upper side plates of the pair of upper side plates are secured to the middle ledge of one of the middle side plates, the pair of lower side plates are connected to the pair of middle side plates by aligning the middle rectangular member of the pair of middle side plates to the lower ledge of the pair of lower side plates.

20. The modular enclosure of claim 19, wherein the modular enclosure further includes an intentionally adequate gap designed to install plumbing, fans or resistive heat coils in the modular enclosure to thermally regulate a heating or a cooling of the battery.
